(19) United States
(12) Patent Application Publication
(10) Pub. No.: US 2026/0328731 A1
(43) Pub. Date: Oct. 22, 2026

(54) MOBILE PHOTOACOUSTIC INSPECTION APPARATUS FOR DETECTING DEFECTS IN LARGE-SCALE INDUSTRIAL FACILITIES

(71) Applicant: Servostar Co.,Ltd, Siheung-si (KR)

(72) Inventors: Hae Sook HWANG, Seoul (KR); Jang Hee KIM, Ansan-si (KR)

(73) Assignee: Servostar Co.,Ltd, Siheung-si (KR)

(21) Appl. No.: 19/690,001

(22) Filed: May 27, 2026

(30) Foreign Application Priority Data
Mar. 27, 2025 (KR) 10-2025-0039546

(51) Int. Cl. G01N 29/24; G01N 29/04; G01N 29/44

(52) U.S. Cl. CPC G01N 29/2418; G01N 29/04; G01N 29/4445

(57) ABSTRACT

A mobile photoacoustic inspection apparatus for detecting defects in large-scale industrial facilities, includes: a movable base having wheels to enable movement to an object to be inspected; a lifting support installed to be capable of moving up and down on the movable base; a front support installed at a front side of the lifting support; a pair of support rods that protrude forward from the front support side by side, wherein a tip of each support rod is supported in contact with a surface of the object to be inspected; and a photoacoustic inspector which is installed on the front support and configured to generate photoacoustic waves by irradiating a laser without physical contact with the object to be inspected and inspect internal defects of the object to be inspected in a non-contact manner using the generated photoacoustic waves.

### CROSS-REFERENCE TO RELATED PATENT APPLICATION

This application claims priority to Korean Patent Application No. 10-2025-0039546 (filed on Mar. 27, 2025), which is hereby incorporated herein by reference in its entirety.

### ACKNOWLEDGEMENT

This research was supported by the Ministry of Trade, Industry and Energy (MOTIE) under the Machinery and Equipment Industry Technology Development Program, managed by the Korea Planning & Evaluation Institute of Industrial Technology (KEIT) (Project Unique No. Not Assigned; Project No. RS-2024-00442735, “Development of a Mobile Opto-Ultrasonic Inspection System for Defect Detection in Large Industrial Facilities”), and was carried out by Servostar Co., Ltd. during the research period from Jul. 1, 2024 to Mar. 31, 2027.

### BACKGROUND

The present disclosure relates to a technology for detecting defects in large-scale industrial facilities, and more specifically, to a mobile photoacoustic inspection apparatus having a mobile structure that is capable of securing inspection precision by stably suppressing shaking that may occur during non-contact inspection of large-scale industrial facilities.

Due to the structural characteristics of large industrial facilities, such as petrochemical plants, storage tanks, and refining equipment, which are often installed at high altitudes or occupy large areas, defect inspections frequently rely on visual inspection or manual methods, presenting limitations in terms of inspector safety and inspection accuracy.

To overcome these limitations, the development of systems capable of performing non-contact inspections while automatically moving inspection equipment is currently being actively pursued, such as the ‘Ultrasonic Non-Destructive Inspection System Using a Mobile Robot’ disclosed in Korean Patent Application Publication No. 10-2024-0107833.

However, when performing inspections on large-scale industrial facilities that are relatively tall, if an inspection device or its supporting structure shakes even slightly, it is difficult to obtain accurate inspection signals, which consequently leads to a problem where the reliability of inspection images and defect evaluation is reduced.

For example, when the point to be inspected is located more than 10 meters above the ground, the support structure supporting the inspection device becomes unstable and the influence of wind becomes stronger, which has a significant impact on the quality of the inspection signal, and this is particularly critical in laser-based non-contact inspection methods.

Related Art: Korean Patent Application Publication No. 10-2024-0107833 (Jul. 9, 2024)

### SUMMARY

Accordingly, the present disclosure is proposed to resolve the aforementioned conventional problems, and an object of the present disclosure is to provide a mobile photoacoustic inspection apparatus that ensures inspection accuracy and reliability by implementing a structure capable of stably contacting and supporting an object to be inspected without shaking, even in high-height inspection environments, while utilizing the advantages of a non-contact inspection method using photoacoustic waves.

To achieve the above objects, a mobile photoacoustic inspection apparatus for detecting defects in large-scale industrial facilities according to the technical spirit of the present disclosure includes a movable base equipped with wheels to enable movement to an object to be inspected, a lifting support installed to be capable of moving up and down on the movable base, a front support installed at a front side of the lifting support, a pair of support rods which protrude forward from the front support side by side, wherein a tip of each support rod is supported in contact with a surface of the object to be inspected, and a photoacoustic inspector which is installed on the front support and configured to generate photoacoustic waves by irradiating a laser without physical contact with the object to be inspected and detect internal defects of the object to be inspected in a non-contact manner using the generated photoacoustic waves.

Here, the tip of the support rod may be provided with an elastic contact member configured to be deformed according to a surface shape of the object to be inspected to maximize a contact area.

In addition, the tip of the support rod may have a contact switch installed therein, which is pressed together to generate a detection signal when the elastic contact member comes into contact with the object to be inspected and is pressed above a predetermined value.

In addition, the elastic contact member may be formed to have a convex curved front surface to be deformed according to the surface shape of the object to be inspected and a central portion of the front surface may preferentially contact the object to be inspected, and the elastic contact member may have an accommodation groove formed in a central portion of a rear surface to accommodate the contact switch so that the contact switch is pressed and switched by only a predetermined amount of pressing of the central portion of the front surface.

In addition, a switch housing that accommodates the contact switch therein and is elastically returned forward by a rear spring may be provided at the tip of the support rod, and, when the elastic contact member in contact with the object to be inspected is pressed, the switch housing may move rearward together such that the contact switch is pressed and switched, and a protrusion may be formed on a front surface of the switch housing to be coupled to a rear accommodation groove of the elastic contact member, and thus the elastic contact member is detachably mounted to the switch housing.

In addition, the elastic contact member may be formed as a shape-adaptive elastic contact member including an elastic outer shell deformable according to the shape of the object to be inspected, a pressure application line that can apply or release pressure inside the elastic outer shell, and an adhesive member disposed on a bottom surface of the elastic outer shell to provide a contact fixing force.

In addition, the adhesive member may be made of a dielectric reactive material whose stiffness changes according to the application of an electric field, deformed according to the shape of the object to be inspected when no electric field is applied, may have its stiffness increased to maintain the deformed shape when an electric field is applied, and have an electrostatic force generated between the contact member and the object to be inspected when an electric field is applied to improve a contact fixing force.

In addition, the pressure application line may be configured to inject or discharge a fluid into or from the elastic outer shell to cause the elastic outer shell to expand or contract according to the shape of the object to be inspected, and control an internal pressure to maintain the deformed shape.

In addition, the shape-adaptive elastic contact member may include a spherical adsorption structure in which a plurality of pores are arranged in a predetermined pattern so as to be adaptable to the surface shape of the object to be inspected, and the adsorption structure may contract when a vacuum is applied and adheres to the surface of the object to be inspected to generate an adsorption force, and be configured to maintain the shape for a predetermined period of time while the vacuum state is maintained.

Additionally, the shape-adaptive elastic contact member may further include a magnetorheological elastomer containing magnetic particles, the magnetorheological elastomer may be formed in a pattern structure in which magnetic particles are arranged to be spaced apart from each other in the form of multiple strips, be freely deformed to conform to the shape of the object to be inspected with low stiffness when no magnetic field is applied, and be configured such that the magnetic particles are aligned to increase the stiffness of the elastomer when a magnetic field is applied, thereby allowing the deformed shape to be maintained in the fixed state.

In addition, the support rod may have a rear end coupled to a slider movable along a rail formed on the front support and may be configured to move forward to protrude or move rearward according to the movement of the slider.

In addition, the slider may stop at a predetermined position according to a detection signal from a contact switch installed at the tip of the support rod, and may be controlled so that the photoacoustic inspector irradiates a laser to generate photoacoustic waves while in a stopped state.

In addition, the apparatus may further include a connecting member integrally connecting the two support rods in order to prevent shaking or twisting during inspection in a state in which the support rods protrude long toward the object to be inspected.

In addition, the front support may be formed as a frame structure including a pair of rails for moving the support rod forward and backward, a slider movable along each rail, and a connecting frame that connects the pair of rails to form a support structure.

In addition, the connecting frame may be provided with a straight frame and a V-shaped frame connecting the pair of rails, and the photoacoustic inspector may be fixedly installed in a form supported by being caught across central protrusions of the straight frame and the V-shaped frame.

A mobile photoacoustic inspection apparatus according to the present disclosure is capable of reliably performing non-contact defect inspection using photoacoustic waves on the outer surface of large-scale industrial facilities.

In particular, even when the object to be inspected is at a high position, a pair of support rods contact the object to be inspected and stably support the inspection apparatus without shaking, thereby ensuring the precision and repeatability of the inspection signal.

In addition, the tip of the support rod is equipped with an elastic contact member that can be deformed according to the shape of the object to be inspected, allowing for effective contact even with curved or irregular surfaces, and is linked with a switch structure that detects contact with the object to be inspected, enabling control of inspection timing and position alignment.

Furthermore, since the elastic contact member may be implemented as a shape-adaptive structure, by applying a vacuum adsorption structure or a magnetorheological elastomer, the shape may be fixed after contact and a stable contact state may be maintained even against external vibrations.

Accordingly, the present disclosure provides a useful technical effect of simultaneously ensuring structural stability and inspection reliability even in a high-precision non-contact inspection environment.

### BRIEF DESCRIPTION OF THE DRAWINGS

FIG. 1 is a view illustrating a state of use of a mobile photoacoustic inspection apparatus according to an embodiment of the present disclosure.

FIG. 2 is a side view illustrating a configuration of a mobile photoacoustic inspection apparatus according to an embodiment of the present disclosure.

FIG. 3 is a plan view of a mobile photoacoustic inspection apparatus according to an embodiment of the present disclosure.

FIG. 4 is a partial side view illustrating configurations of a front support and a support rod in a mobile photoacoustic inspection apparatus according to an embodiment of the present invention.

FIG. 5 is a bottom view illustrating a frame structure of a front support in a mobile photoacoustic inspection apparatus according to a modified embodiment of the present disclosure.

FIG. 6 is a partial side view illustrating a deformed elastic contact member in a mobile photoacoustic inspection apparatus according to a modified embodiment of the present disclosure.

FIG. 7 is a reference diagram for explaining an adhesive surface pattern of a deformed elastic contact member in a mobile photoacoustic inspection apparatus according to a modified embodiment of the present disclosure.

### DETAILED DESCRIPTION

A mobile photoacoustic inspection apparatus according to embodiments of the present disclosure will be described in detail with reference to the accompanying drawings. Various modifications may be made to the present disclosure and the present disclosure may take various forms, and specific embodiments are illustrated in the drawings and described in detail in the detailed description. However, it should be understood that this is not intended to limit the invention to the specific disclosed forms and includes all modifications, equivalents, and substitutions that fall within the spirit and scope of the present disclosure. In describing each drawing, similar reference numerals were used for similar components. In the accompanying drawings, the dimensions of the structures are depicted enlarged compared to the actual size to ensure clarity of the invention, or reduced compared to the actual size to facilitate understanding of the schematic configuration.

Additionally, terms such as first and second may be used to describe various components, but the components should not be limited by the terms. The above terms are used solely for the purpose of distinguishing one component from another. For example, without departing from the scope of the present disclosure, a first component may be named a second component, and similarly, the second component may also be named the first component. Meanwhile, unless otherwise defined, all terms used herein, including technical or scientific terms, have the same meaning as generally understood by those skilled in the art to which the present disclosure pertains. Terms such as those defined in commonly used dictionaries should be interpreted as having meanings consistent with their meanings in the context of the relevant technology, and should not be interpreted in an ideal or overly formal sense unless explicitly defined in this application.

### EMBODIMENTS

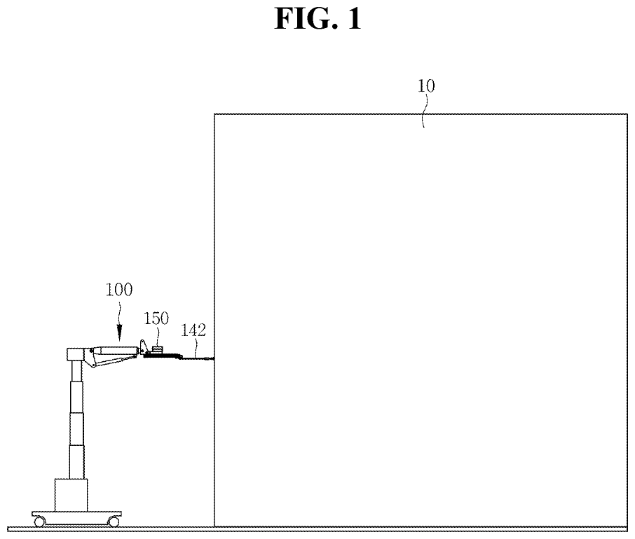

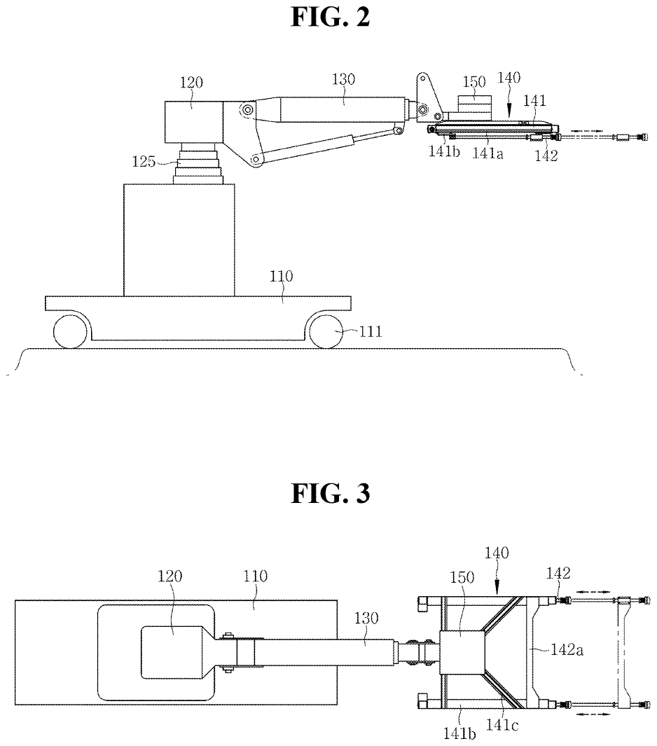

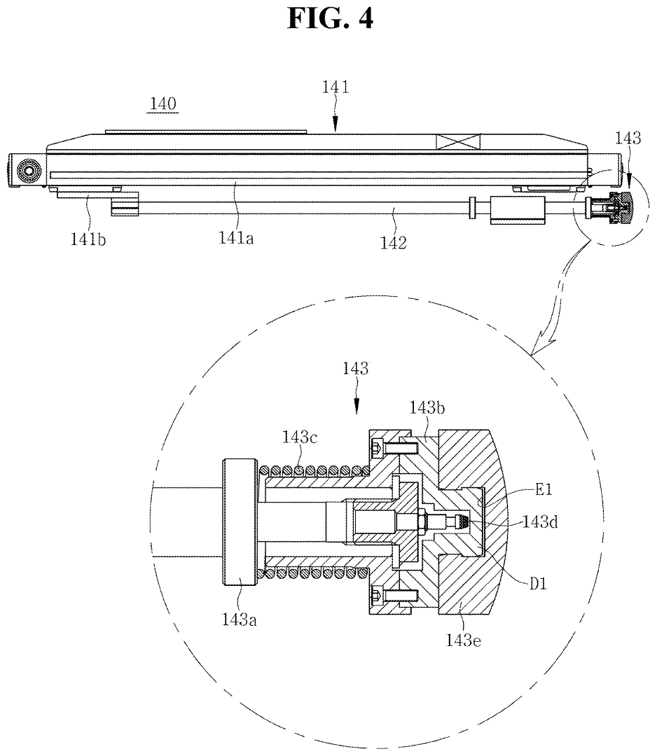

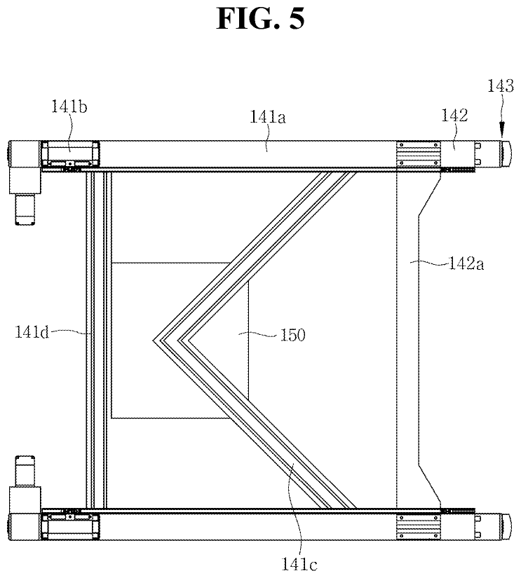

FIG. 1 is a diagram showing a state of use of a mobile photoacoustic inspection apparatus according to an embodiment of the present disclosure, and FIG. 2 is a side view illustrating a configuration of the mobile photoacoustic inspection apparatus according to the embodiment of the present disclosure. FIG. 3 is a plan view of the mobile photoacoustic inspection apparatus according to the embodiment of the present disclosure, and FIG. 4 is a partial side view for explaining configurations of a front support and a support rod in the mobile photoacoustic inspection apparatus according to the embodiment of the present disclosure.

As shown in the drawings, a mobile photoacoustic inspection apparatus 100 according to the embodiment of the present disclosure includes a movable base 110, a lifting support 120, a front support 140, a pair of support rods 142, and a photoacoustic inspector 150 as main components, and is configured to enable stable support and precise inspection by applying a shaking suppression structure through the support rods 142 to an object to be inspected 10 located at a high position of about 10 m or more above the ground, while maintaining the advantages of a non-contact inspection method using photoacoustic waves.

Hereinafter, the mobile photoacoustic inspection apparatus according to the embodiment of the present disclosure will be described in detail, focusing on each of the above-described components.

The movable base 110, as a base structure that enables movement around the object to be inspected, is configured to have a plurality of wheels 111 on a lower part thereof so that the apparatus may be easily moved to an inspection position.

In order to stop moving and maintain a stable posture after reaching the inspection position, the wheel 111 may be equipped with a fixing means such as a locking device or a stopper. This prevents unstable shaking or displacement of the apparatus during inspection.

The lifting support 120 is installed above the movable base 110, and it performs a supporting role so that the upper structure can be lifted according to the height of the inspection position. In this way, the movable base 110 stably supports the entire mobile photoacoustic inspection apparatus according to the embodiment of the present disclosure and provides a base on which the lifting function can operate.

In addition, the movable base 110 of the present disclosure is applied to large-scale industrial facilities, such as storage tanks or piping structures, which require inspection of a wide area, thereby improving work efficiency and operational convenience by allowing continuous inspection to be performed while freely changing the inspection position.

The lifting support 120 is installed on the movable base 110 and is formed in a structure to be vertically movable so as to adjust the overall height of the apparatus according to the height of the object to be inspected. This enables the front support 140 and the photoacoustic inspector 150 to accurately reach the inspection position of the object to be inspected.

The lifting support 120 may be configured as, for example, support bars 125 having a multi-stage sliding structure, and is formed in a telescopic shape in which the support bars 125 of respective stages are coupled to be extendable and retractable like a telescope. In particular, the lifting support 120 is configured such that a plurality of support bars 125 may be inserted or withdrawn stepwise in the vertical direction and adjusted to a desired height according to the inspection position.

The support bars 125 constituting the lifting support 120 are each designed to have a certain cross-sectional strength to prevent shaking or bending that may occur during lifting, and to allow the inspection apparatus to be stably supported while fixed. In addition, each support bar 125 is provided with a guide rail 141a, a locking device, or an anti-interference structure installed on the inner or outer side thereof to maintain alignment and stability during lifting.

The lifting operation of the lifting support 120 may be driven through operating means such as an electric motor, hydraulic or pneumatic cylinder, and may also be manually operated as needed. The lifting support 120 secures a height to reach the object to be inspected even when the object to be inspected is disposed at a height of about 10 m or more, thereby enabling stable photoacoustic inspection even in a high-position inspection environment.

The front support member 140 is formed in a structure that is connected to an upper end of the lifting support 120 and supports and guides the pair of support rods 142 and the photoacoustic inspector 150. The front support 140 forms a structural base for stably positioning the photoacoustic inspector 150 and the support rod 142 according to the inspection position and maintaining alignment of the photoacoustic irradiation direction.

The front support 140 is composed of a front-rear direction rail 141a for moving a pair of support rods 142 in a front-rear direction, a slider 141b that moves along the corresponding rail 141a, and a connecting frame 142b that connects the rails 141a to maintain overall frame rigidity.

The connecting frame 142b is composed of a straight frame 141d and a V-shaped frame 141C, each having a different functional role. The straight frame 141d is disposed to extend along the front or rear of the rail 141a and serves to guide the movement of the slider 141b and maintain a constant spacing of the rail 141a. In contrast, the V-shaped frame 141C is disposed diagonally with a sufficient spacing from the straight frame 141d so as to more stably support the structure of the rail 141a formed to extend in the front-rear direction.

This provides a support structure that can stably fix the photoacoustic inspector 150 without a separate horizontal reinforcement frame. In particular, the photoacoustic inspector 150 is installed in a form that is supported by being caught on a central protrusion between the V-shaped frame 141C and the straight frame 141d.

This structure allows the photoacoustic inspector 150 to be aligned at the center of the front support 140 and to be accurately disposed at the center of a gap between the support rods 142. As a result, the direction of photoacoustic generation is precisely guided toward the exact center of the surface of the object to be inspected, thereby increasing the accuracy of the irradiation position and the reliability of the inspection.

The front support 140 is also entirely supported by an intermediate support arm 130 installed at the rear. The intermediate support arm 130 may rotate in the vertical direction in conjunction with a cylinder or cylinder rod, thereby allowing the angle of the front support 140 to be adjusted. The configuration of the intermediate support arm 130 suppresses structural shaking and simultaneously supports precise adjustment of the angle of the photoacoustic inspector 150 to the position of the object to be inspected.

Consequently, the front support 140 integrates a movement structure of the slider 141b, a center placement structure of the photoacoustic inspector 150, and the angle adjustment structure, thereby providing a basis for effectively performing precise non-contact inspection using photoacoustic waves.

The support rod 142 is disposed to protrude forward from the front support 140 and contact the surface of the object to be inspected, and plays a key role in maintaining a constant relative position between the object to be inspected and the photoacoustic inspector 150, and suppressing shaking of the entire apparatus during inspection to increase inspection precision. The support rods 142 are provided in a pair, and each of the support rods 142 is installed to be movable forward and backward by the slider 141b along left and right rails 141a formed on the front support 140. Thus, the support rod 142 is configured to protrude forward to contact the surface of the object to be inspected when preparing for inspection, and to move rearward when the inspection is completed or waiting.

The tip of the support rod 142 is provided with an elastic contact module 143, which centers around an elastic contact member 143e configured to be deformed according to the surface shape of the object to be inspected to maximize a contact area. The elastic contact member 143e is formed to have a convex curved front surface to naturally adhere to the surface of the object to be inspected that has a curved or uneven surface, and maintain a stable contact state during inspection. In particular, the elastic contact member 143e is composed of a urethane pad, and the urethane material has excellent elastic deformation and recovery power under external load, is not easily deformed even with repeated contact, and has excellent durability and wear resistance, making it suitable for repeated inspection environments.

An accommodation groove E1 for accommodating the contact switch 143d is formed in a central portion of a rear surface of the elastic contact member 143e, and the switch housing 143b accommodating the contact switch 143d therein is inserted into the accommodation groove E1. The switch housing 143b is installed in a structure that elastically returns to the front by the rear spring 143c supported by the stopper 143a, and when the elastic contact member 143e comes into contact with the object to be inspected and is pressed beyond a predetermined amount while in the inspection preparation state, the switch housing 143b moves rearward together and presses the internal contact switch 143d to generate a detection signal. Through this structure, the support rod 142 may electrically detect whether there is actual contact with the object to be inspected, and control the laser irradiation timing of the photoacoustic inspector 150 based on the detected signal.

Additionally, a protrusion D1 is formed on a front surface of the switch housing 143b to be coupled to the accommodation groove E1 of the elastic contact member 143e, and accordingly, the elastic contact member 143e is detachably mounted to the switch housing 143b. This structure allows the elastic contact member 143e to be easily replaced according to the user's needs and enables compatibility with various elastic contact members 143e depending on the material or surface shape of the object to be inspected.

To prevent shaking or twisting during inspection and to improve structural stability, the connecting member 142a for integrally connecting the support rods 142 is further installed between the pair of support rods 142. The connecting member 142a allows the pair of support rods 142 to move simultaneously while maintaining a predetermined distance, thereby contributing to maintaining stable contact force at the inspection position and preventing distortion of the support structure.

The configuration of the support rod 142 improves the accuracy and reliability of non-contact inspection using photoacoustic waves by satisfying all of the following: contactability adaptable to various surface shapes of the object to be inspected, control interlocking based on contact detection, and structural stability during inspection.

The photoacoustic inspector 150 generates ultrasound using a laser so as to detect internal defects non-destructively without physically contacting the surface of the object to be inspected, and receives the generated ultrasound in a non-contact manner to determine whether there is a defect. The photoacoustic inspector 150 instantaneously irradiates short, strong energy onto the surface of the object to be inspected based on a laser, and as a result, rapid thermal expansion occurs on the surface, inducing a thermoelastic wave, and this thermoelastic wave is converted into ultrasound and propagates along the interior of the object to be inspected. The transmitted ultrasound is reflected at defects or boundaries within the material, and the reflected ultrasound may be sensed again in a non-contact manner to image information about internal damage or defects.

The photoacoustic inspector 150 may be composed of an ultrasonic generating device based on a Q-switched laser and a receiving device including a continuous wave laser interferometer or a Laser Doppler Vibrometer (LDV) sensor, and the two devices are arranged on the same plane at a predetermined distance apart to simultaneously scan the surface of the object to be inspected. By sensing ultrasound propagating in the thickness direction in real time, ultrasound propagation images or C-scan images are generated based on data in the time or frequency domain, and various internal damages such as cross-sectional defects, interlayer delamination, and foreign substance infiltration may be visualized. This photoacoustic technology may be effectively applied even to structures or curved surfaces where physical contact is difficult, as well as in high-temperature environments, leading to expanded utilization in various industrial fields.

The photoacoustic inspector 150 is fixedly installed to be caught on the central protrusions of the straight frame 141d and the V-shaped frame 141C of the connecting frame 142b of the front support 140. With this configuration, the photoacoustic inspector 150 is stably disposed in a central location between the support rods 142 while maintaining the rigidity of the entire apparatus, and there is an advantage of minimizing the alignment error between the irradiation direction and the target surface. In particular, the V-shaped frame 141C supports the structure of the rail 141a formed to extend in the front-rear direction, and also provides an angle and space to fix the photoacoustic inspector 150 without an additional frame, which is advantageous in terms of structural simplicity and installation precision.

The photoacoustic inspector 150 based on such a structure and technology has the advantage of being able to perform precise non-contact inspection even at high locations or hard-to-access areas of large-scale industrial facilities, and to detect defects with high resolution and high reliability.

The mobile photoacoustic inspection apparatus according to the embodiment of the present disclosure is configured to inspect the external surface of large and high industrial facilities, such as storage tanks, in a non-contact manner, and includes a movable base, the height-adjustable lifting support 120, the front support 140 that guides the support rod 142, the pair of support rods 142 that support the object to be inspected, and the photoacoustic inspector 150 that generates and receives photoacoustic waves based on a laser.

The mobile photoacoustic inspection apparatus according to the embodiment of the present disclosure secures structural stability and rigidity so as to accurately maintain the inspection point without shaking even at a high position of 10 m or more, and the tip of the support rod 142 is provided with the elastic contact member 143e based on a urethane pad that is adaptable to a curved surface, thereby maximizing the contact area with the object to be inspected and increasing the accuracy of the inspection signal. In addition, a connection structure between a switch structure for contact detection and the support rod 142, and the support method of the frame-integrated photoacoustic inspector 150 are combined to provide a hardware basis for performing non-contact photoacoustic inspection precisely and stably.

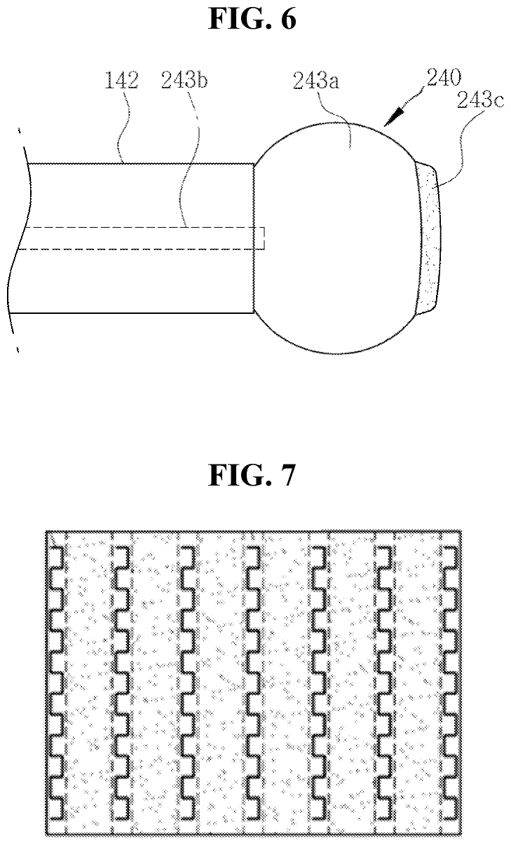

FIG. 6 is a partial side view illustrating a deformed elastic contact member in a mobile photoacoustic inspection apparatus according to a modified embodiment of the present disclosure, and FIG. 7 is a reference diagram illustrating an adhesive member surface pattern of the deformed elastic contact member in the mobile photoacoustic inspection apparatus according to the modified embodiment of the present disclosure.

The tip portion of the support rod 142 according to the modified embodiment may be provided with a modified shape-adaptive elastic contact member that can more actively adapt to the external shape while improving contact stability and fixing force.

As shown in FIG. 6, a shape-adaptive elastic contact member 240 is installed at the tip of the support rod 142, and the elastic contact member 240 includes an elastic outer shell 243a, a pressure application line 243b, and an adhesive member 243c.

The elastic outer shell 243a is formed in a hemispherical or curved shape and is made of a highly elastic material such as silicone, urethane, or EPDM so as to be flexibly deformable according to the curved shape of the object to be inspected. The pressure application line 243b is connected to the inside of the elastic outer shell 243a to inject or discharge air or fluid, and by controlling pressure inside the elastic outer shell 243 a through the pressure application line 243b, the outer shell expands or contracts and adapts to the shape of the object to be inspected.

When an internal pressure is maintained after applying pressure, the elastic outer shell 243a may maintain its deformed shape for a predetermined period of time, which contributes to fixing the contact shape and ensuring positional stability during inspection. The adhesive member 243c is provided at the front of the elastic outer shell 243a, and the adhesive member 243c directly contacts the object to be inspected to provide a tight fixing force.

The adhesive member 243c may include a dielectric reactive adhesive, an electrostatic adhesive layer, or a vacuum adsorption structure, the stiffness of which changes according to the application of an electric field, and thereby can initially adhere flexibly, maintain a fixed shape after contact, or increase contact stability through adsorption force.

Accordingly, the shape-adaptive elastic contact member 240 shown in FIG. 6 is configured to simultaneously improve contact precision and inspection reliability in an inspection environment by integrating the shape deformation and fixation of the elastic outer shell 243a, securing stable adhesion, and the function of detecting contact.

The shape-adaptive elastic contact member 240 according to the modified embodiment includes a magnetorheological elastic body containing magnetic particles therein, and the magnetorheological elastic body may be formed in a structure in which magnetic particles are arranged in a plurality of strip patterns spaced apart at regular intervals, as shown in FIG. 7.

Magnetorheological elastomers are generally formed by dispersing iron-based or iron oxide-based magnetic particles (e.g., Fe₃O₄, Fe, etc.) within a polymer material such as silicone rubber, polyurethane, or PDMS. The magnetic particles are not distributed uniformly throughout, but are arranged in sections in the shape of multiple vertical strips, thereby being configured to generate a more dramatic change in stiffness before and after the application of a magnetic field. In the above structure, when no magnetic field is applied, the interaction between magnetic particles is minimal, and the entire elastic body maintains low stiffness, so it can be freely deformed according to the curved or irregular surface shape of the object to be inspected.

Accordingly, it can make soft contact during initial contact while adhering closely to a wide area, and provides the effect of evenly conforming to the shape of the object to be inspected. On the other hand, when a magnetic field is applied, the magnetic particles inside each strip align in the direction of the magnetic field lines, forming a microscopic particle structure inside the elastic body. As a result, the shear stiffness of the elastic body increases rapidly, and it is fixed in a state where it does not easily deform even under external pressure.

In other words, it is possible to maintain the deformed shape as is, and during inspection, it has the effect of maintaining stability without shaking of the contact position. Compared to conventional uniform magnetorheological structures in which magnetic particles are distributed evenly, this strip-shaped pattern structure can maintain low initial stiffness while rapidly and strongly inducing a stiffness amplification response when a magnetic field is applied. This can be applied particularly effectively in environments where the inspection target changes repeatedly, or in surface inspection environments with varying curvatures.

Accordingly, the shape-adaptive elastic contact member 240 including the pattern structure shown in FIG. 7 realizes a dual function of actively conforming to the surface shape of an irregular structure while maintaining a fixed state using a magnetic field, which contributes to further improving the precision and reliability of the photoacoustic non-contact inspection apparatus.

Although preferred embodiments of the present disclosure have been described above, the present disclosure may use various variations, modifications, and equivalents. It is clear that the present disclosure can be applied in the same way by appropriately modifying the above embodiments. Therefore, the above description does not limit the scope of the present disclosure as defined by the limitations of the appended claims.

### EXPLANATION OF SYMBOLS

110: Movable base
120: Lifting support
130: Intermediate support arm
140: Front support
143: Elastic contact module
150: Photoacoustic inspector

1. A mobile photoacoustic inspection apparatus for detecting defects in large-scale industrial facilities, the mobile photoacoustic inspection apparatus comprising:
a movable base having wheels to enable movement to an object to be inspected;
a lifting support installed to be capable of moving up and down on the movable base;
a front support installed at a front side of the lifting support;
a pair of support rods that protrude forward from the front support side by side, wherein a tip of each support rod is supported in contact with a surface of the object to be inspected; and
a photoacoustic inspector which is installed on the front support and configured to generate photoacoustic waves by irradiating a laser without physical contact with the object to be inspected and inspect internal defects of the object to be inspected in a non-contact manner using the generated photoacoustic waves.

2. The mobile photoacoustic inspection apparatus of claim 1, wherein the tip of the support rod is provided with an elastic contact member configured to be deformed according to a surface shape of the object to be inspected to maximize a contact area.

3. The mobile photoacoustic inspection apparatus of claim 2, wherein a contact switch, which is pressed together to generate a detection signal when the elastic contact member comes into contact with the object to be inspected and is pressed at a predetermined value or more, is installed at the tip of the support rod.

4. The mobile photoacoustic inspection apparatus of claim 3, wherein the elastic contact member is formed to have a convex curved front surface to be deformed according to the surface shape of the object to be inspected, and a central portion of the front surface preferentially contacts the object to be inspected, and
the elastic contact member has an accommodation groove formed in a central portion of a rear surface to accommodate the contact switch so that the contact switch is pressed and switched by only a predetermined amount of pressing of the central portion of the front surface.

5. The mobile photoacoustic inspection apparatus of claim 4, wherein a switch housing that accommodates the contact switch therein and is elastically returned forward by a rear spring is provided at the tip of the support rod, and, when the elastic contact member in contact with the object to be inspected is pressed, the switch housing moves rearward together such that the contact switch is pressed and switched,
a protrusion coupled to the rear surface accommodation groove of the elastic contact member is formed on a front surface of the switch housing, and the elastic contact member is detachably mounted to the switch housing.

6. The mobile photoacoustic inspection apparatus of claim 2, wherein the elastic contact member is a shape-adaptive elastic contact member comprising an elastic outer shell deformable according to the shape of the object to be inspected, a pressure application line that enables application or release of pressure inside the elastic outer shell, and an adhesive member disposed on a bottom surface of the elastic outer shell to provide a contact fixing force.

7. The mobile photoacoustic inspection apparatus of claim 6, wherein the adhesive member is made of a dielectric reactive material whose stiffness changes according to the application of an electric field, is deformed according to the shape of the object to be inspected when no electric field is applied, increases its stiffness to maintain the deformed shape when an electric field is applied, and generates an electrostatic force between the adhesive member and the object to be inspected when an electric field is applied to improve the contact fixing force.

8. The mobile photoacoustic inspection apparatus of claim 6, wherein the pressure application line is configured to inject or discharge a fluid into or from the elastic outer shell, thereby causing the elastic outer shell to expand or contract according to an external shape of the object to be inspected, and controlling an internal pressure to maintain the deformed shape.

9. The mobile photoacoustic inspection apparatus of claim 6, wherein the shape-adaptive elastic contact member comprises a spherical adsorption structure in which a plurality of pores are arranged in a predetermined pattern to be adaptable to the surface shape of the object to be inspected, and the adsorption structure contracts when a vacuum is applied to adhere to the surface of the object to be inspected and generate an adsorption force, and is configured to maintain the shape for a predetermined period of time while the vacuum state is maintained.

10. The mobile photoacoustic inspection apparatus of claim 6, wherein the shape-adaptive elastic contact member further comprises a magnetorheological elastomer containing magnetic particles, and
the magnetorheological elastomer is formed in a pattern structure in which magnetic particles are arranged to be spaced apart from each other in the form of multiple strips, is freely deformed to conform to the shape of the object to be inspected with low stiffness when no magnetic field is applied, and is configured such that the magnetic particles are aligned to increase the stiffness of the elastomer when a magnetic field is applied, thereby allowing the deformed shape to be maintained in a fixed state.

11. The mobile photoacoustic inspection apparatus of claim 1, wherein the support rod has a rear end coupled to a slider movable along a rail formed on the front support, and is configured to move forward and protrude or move rearward according to the movement of the slider.

12. The mobile photoacoustic inspection apparatus of claim 11, wherein the slider stops at a predetermined position according to a detection signal from the contact switch installed at the tip of the support rod, and in the stopped state, the photoacoustic inspector is controlled to irradiate a laser to generate photoacoustic waves.

13. The mobile photoacoustic inspection apparatus of claim 11, wherein a connecting member is further installed between the pair of support rods to integrally connect the two support rods in order to prevent shaking or twisting during inspection in a state in which the support rods protrude long toward the object to be inspected.

14. The mobile photoacoustic inspection apparatus of claim 11, wherein the front support is formed as a frame structure comprising a pair of rails for moving the support rods forward and rearward, a slider movable along each rail, and a connecting frame that connects the pair of rails to form a support structure.

15. The mobile photoacoustic inspection apparatus of claim 14, wherein the connecting frame comprises a straight frame and a V-shaped frame that connect the pair of rails, and
the photoacoustic inspector is fixedly installed in a form supported by being caught on central protrusions of the straight frame and the V-shaped frame.
